(19) United States
(12) Patent Application Publication
(10) Pub. No.: US 2020/0021212 A1
(43) Pub. Date: Jan. 16, 2020

(54) MOTOR CONTROLLER, BRUSHLESS MOTOR, FAN, AND MOTOR CONTROL METHOD

(71) Applicant: Nidec Corporation, Kyoto (JP)

(72) Inventors: Masahiro YAMADA, Kyoto (JP); Daisuke SHIMIZU, Kyoto (JP)

(21) Appl. No.: 16/471,041

(22) PCT Filed: Dec. 28, 2017
(86) PCT No.: PCT/JP2017/047357

§ 371 Date: Jun. 19, 2019

(30) Foreign Application Priority Data
Feb. 2, 2017 (JP) 2017-017907

(51) Int. Cl. H02P 6/10

(52) U.S. Cl. CPC H02P 6/10

(57) ABSTRACT

A motor controller includes an energization pattern determiner that determines an energization pattern that specifies a coil to be energized, and a current supply that, assuming that an energization period is a time from determination of the energization pattern to determination of a next energization pattern, supplies a current to a coil specified by the energization pattern in the energization period. The current supply includes a first operation mode in which the energization period is only a supply period that supplies a current, and a second operation mode in which the energization period includes the supply period and a stop period that stops current supply.

### CROSS REFERENCE TO RELATED APPLICATIONS

This is the U.S. national stage of PCT Application No. PCT/JP2017/047357, filed on Dec. 28, 2017, and priority under 35 U.S.C. § 119(a) and 35 U.S.C. § 365(b) is claimed from Japanese Application No. 2017-017907, filed Feb. 2, 2017; the entire disclosures of which are incorporated herein by reference.

### FIELD OF THE INVENTION

The present disclosure relates to a control method for controlling a brushless motor and a motor controller, and also relates to a brushless motor controlled by the motor controller and a fan using the brushless motor.

### BACKGROUND

Conventionally, a brushless motor is driven by a 120-degree conduction inverter having a three-phase or more AC output with one-phase output having a constant non-energized period between electrical angles of 180 degrees (Japanese Patent Application Laid-Open Publication: No. 6-327286).

However, in the conventional brushless motor, the effective value of current supplied to a coil is high during the energization period, and a circuit capable of supplying a large current is required as a control circuit. This leads to an increase in cost.

In addition, since the effective value of current is high, the amount of heat generation from the coil increases, and the change of magnetic characteristics due to heating of the magnet may reduce efficiency of the motor. In addition, it is necessary to adopt highly heat-resistant parts for the control circuit, which also leads to an increase in cost.

### SUMMARY

A motor controller according to an example embodiment of the present disclosure controls rotation of a brushless motor including a rotor that includes a magnet including magnetic poles, and a stator that includes coils of multiple phases. The motor controller includes an energization pattern determiner that determines an energization pattern that specifies a coil to be energized from the coils of a plurality of phases, and a current supply that, assuming that an energization period is a time from determination of the energization pattern to determination of a next energization pattern, supplies a current to a coil specified by the energization pattern in the energization period. The current supply includes a first operation mode in which the energization period is only a supply period that supplies a current, and a second operation mode in which the energization period includes the supply period and a stop period that stops current supply.

According to example embodiments of motor controllers, brushless motors, and fans of the present disclosure, it is possible to achieve a simple configuration, suppress fluctuation in the rotational accuracy of a rotor, and reduce the effective value of current.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of an example embodiment of a brushless motor of the present disclosure.

FIG. 2 is a schematic view of the brushless motor shown in FIG. 1.

FIG. 3 is a block diagram showing an electrically connected state of the brushless motor.

FIG. 4 is a diagram showing input signals and energization patterns of a switching circuit in a first operation mode according to an example embodiment of the present disclosure.

FIG. 5 is a diagram showing the brushless motor stopped in a first stop position.

FIG. 6 is a diagram showing the brushless motor stopped in a second stop position.

FIG. 7 is a diagram showing the brushless motor stopped in a third stop position.

FIG. 8 is a diagram showing the brushless motor stopped in a fourth stop position.

FIG. 9 is a diagram showing the brushless motor stopped in a fifth stop position.

FIG. 10 is a diagram showing the brushless motor stopped in a sixth stop position.

FIG. 11 is a diagram showing input signals and energization patterns of the switching circuit in a second operation mode.

FIG. 12 is an enlarged view of an energization period in the second operation mode shown in FIG. 11.

FIG. 13 is a diagram showing the minimum value of the sum total of the currents that rotate a rotor in a single energization period.

FIG. 14 is a timing chart showing an operation of a brushless motor according to an example embodiment of the present disclosure.

FIG. 15 is a timing chart showing an operation of a brushless motor according to an example embodiment of the present disclosure.

FIG. 16 is an enlarged cross-sectional view of an essential portion of an example of a fan according to an example embodiment of the present disclosure.

### DETAILED DESCRIPTION

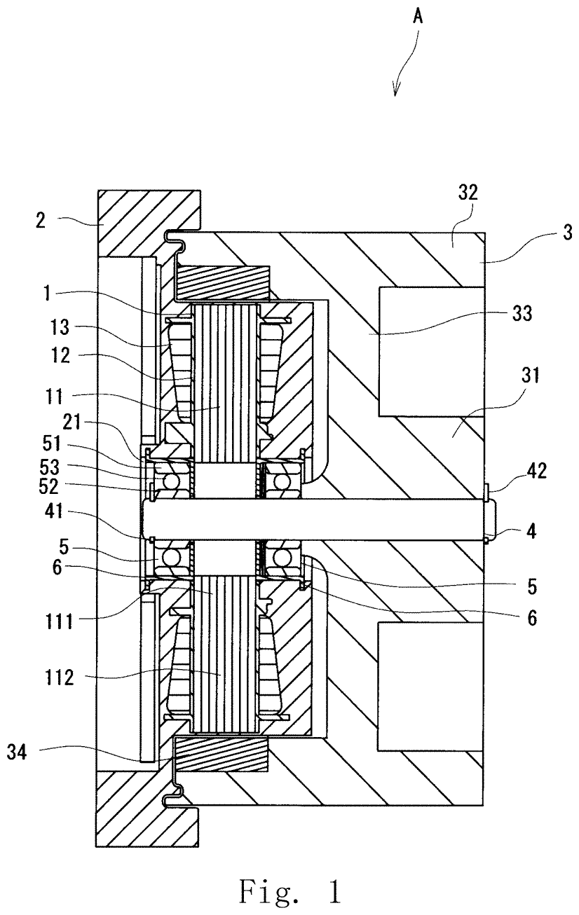

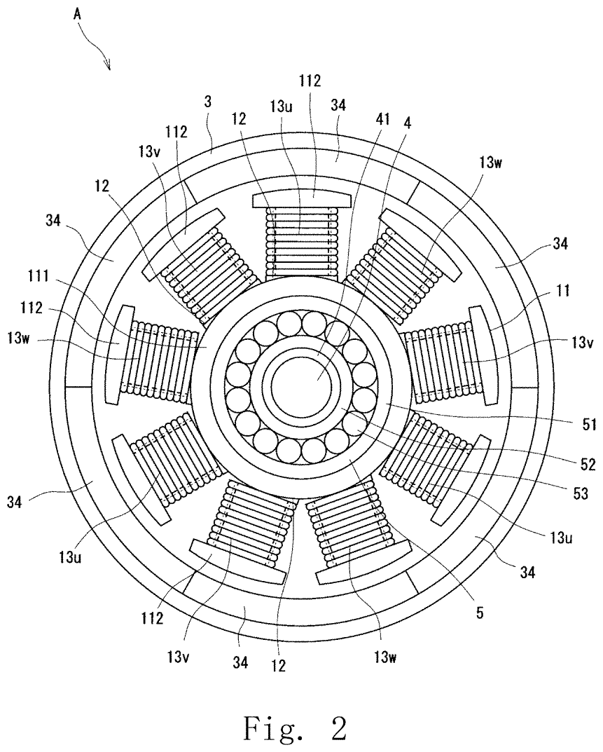

Hereinafter, exemplary example embodiments of the present disclosure will be described with reference to the drawings. FIG. 1 is a cross-sectional view of an example of a brushless motor of the present disclosure. FIG. 2 is a schematic view of the brushless motor shown in FIG. 1. Note that in the following description, it is assumed that the center of a shaft is the central axis, and the shaft rotates about the central axis. The description will be given on the assumption that a direction extending along the central axis is the axial direction, a direction orthogonal to the central axis is the radial direction, and the circumferential direction of a circle centered on the central axis is the circumferential direction. Further, as for the rotation direction of a rotor, the clockwise direction (CW direction) and the counterclockwise direction (CCW direction) are defined based on the brushless motor shown in FIG. 2 as viewed from the upper side of the brushless motor.

As shown in FIG. 1, a brushless motor A of the example embodiment includes a stator 1, a casing 2, a rotor 3, a shaft 4, a bearing 5, and a bearing storage member 6. The stator 1 is covered with the casing 2. The shaft 4 is attached to the rotor 3. Then, the shaft 4 is supported by the casing 2 through the two bearings 5. The rotor 3 includes an annular magnet 34, and is disposed outside the stator 1. That is, the brushless motor A of the example embodiment is an outer rotor type DC brushless motor in which the rotor 3 is attached to the outside of the stator 1. Note that the present disclosure is also applicable to an inner rotor type DC brushless motor. Hereinafter, an outer rotor type DC brushless motor will be exemplified.

The stator 1 has a stator core 11, an insulator 12, and a coil 13. The stator core 11 is configured such that multiple steel plates (electromagnetic steel plates) are stacked on top of one another in the axial direction. That is, the stator core 11 is electrically conductive. Note that the stator core 11 is not limited to the structure in which electromagnetic steel plates are stacked on top of one another, and may be a single member. Examples of the method of manufacturing the stator core 11 include forging or casting, but are not limited thereto. The stator core 11 includes a core back 111 and teeth 112. The core back 111 has in an axially extending cylindrical shape. The teeth 112 protrude radially outward from an outer peripheral surface of the core back 111. As shown in FIG. 2, the stator core 11 includes nine teeth 112. The teeth 112 are arranged at equal intervals in the circumferential direction. That is, in the brushless motor A of the example embodiment, the stator 1 has nine slots.

The insulator 12 covers the teeth 112. The insulator 12 is a resin molded body. The coil 13 is configured such that a conductor wire is wound around the teeth 112 covered with the insulator 12. The insulator 12 insulates the teeth 112, that is, the stator core 11 and the coil 13. Note that while the insulator 12 is a resin molded body in the example embodiment, the disclosure is not limited to this. A wide variety of configurations that can insulate the stator core 11 and the coil 13 may be adopted.

As described above, the insulator 12 insulates the stator core 11 and the coil 13. Accordingly, in the stator core 11, an exposed portion not covered with the insulator 12 is formed around the core back 111.

The nine coils 13 included in the stator 1 are divided into three groups (hereinafter referred to as three phases) which differ in timing of supply of an electric current. The three phases are defined as a U phase, a V phase, and a W phase. That is, the stator 1 includes three U-phase coils 13u, three V-phase coils 13v, and three W-phase coils 13w. As shown in FIG. 2, the U-phase coil 13u, the V-phase coil 13v, and the W-phase coil 13w are arranged in this order in the counterclockwise direction. That is, the V-phase coil 13v is arranged next to the U-phase coil 13u in the counterclockwise direction. Further, the W-phase coil 13w is disposed next to the V-phase coil 13v in the counterclockwise direction. Further, the U-phase coil 13u is disposed next to the W-phase coil 13w in the counterclockwise direction. Note that in the following description, when the three phases do not need to be described separately, the coils of the phases are collectively referred to as the coil 13.

The casing 2 is made of resin, and covers the stator 1 while leaving at least the exposed portion exposed. The casing 2 is a resin molded body. That is, the casing 2 prevents water from wetting the electrical wiring such as the coil 13. The casing 2 is also a case of the brushless motor A. Hence, the casing 2 may be used to fix the device in which the brushless motor A is used, to a frame or the like. For this reason, a resin strong enough to hold the brushless motor A is used to mold the casing 2. The casing 2 is not limited to a molded body, and the stator 1 may be disposed on a resin or metal base member. That is, the stator 1 may be in a non-molded state.

An opening 21 is provided in the central portion at both axial ends of the casing 2. The exposed portion of the core back 111 of the stator 1 is exposed to the outside by the opening 21. The bearing 5 accommodated in the bearing storage member 6 is attached to the opening 21.

As shown in FIG. 2, the bearing 5 is a ball bearing including an outer ring 51, an inner ring 52, and multiple balls 53. The outer ring 51 of the bearing 5 is fixed to an inner surface of a cylindrical portion 61 of the bearing storage member 6. In addition, the inner ring 52 is fixed to the shaft 4.

One end face of the bearing 5 is in contact with the bearing storage member 6. The other end face of the bearing 5 is in contact with a shaft retaining ring 41 attached to the shaft 4. This prevents the shaft 4 from coming off.

The shaft 4 has an axially extending columnar shape. In addition, the shaft 4 is fixed to the inner ring 52 of the two bearings 5 attached to the casing 2 through the bearing storage portion 6. That is, the shaft 4 is rotatably supported by the two bearings 5 at two positions separated in the axial direction.

The shaft retaining ring 41 in contact with the bearing 5 is attached to one axial end of the shaft 4. Further, a shaft retaining ring 42 in contact with the rotor 3 fixed to the shaft 4 is attached to the other axial end of the shaft 4. By attaching the shaft retaining rings 41 and 42, axial movement of the shaft 4 is suppressed. Note that while a C ring or the like may be used as the shaft retaining rings 41, 42, the disclosure is not limited to this.

As shown in FIG. 1, the rotor 3 includes an inner cylinder 31, an outer cylinder 32, a connecting portion 33, and the magnet 34. The inner cylinder 31 and the outer cylinder 32 have axially extending cylindrical shapes. The center lines of the inner cylinder 31 and the outer cylinder 32 coincide with each other. The shaft 4 is fixed to an inner peripheral surface of the inner cylinder 31. One axial end of the inner cylinder 31 is in contact with the bearing 5. Further, the shaft retaining ring 42 is in contact with the other axial end of the inner cylinder 31.

The outer cylinder 32 is disposed on the outer side in the radial direction orthogonal to the axial direction of the stator 1, with a gap interposed therebetween. That is, the stator 1 holds the coils 13u, 13v and 13w of multiple phases such that the coils face the rotor 3 in the radial direction of the shaft 4. The magnet 34 is provided on an inner peripheral surface of the outer cylinder 32. The magnets 34 are arranged in the circumferential direction at positions facing the teeth 112 of the stator core 11 in the radial direction. The magnet 34 may be formed in a ring shape and have multiple magnetic poles, or may be multiple magnets with different magnetic poles. Note that the rotor 3 has a configuration in which six magnets 34 are arranged in the circumferential direction. Of the six magnets 34, adjacent magnets have different magnetic poles. The rotor 3 has six poles.

The connecting portion 33 connects the inner cylinder 31 and the outer cylinder 32. The connecting portion 33 extends radially outward from an outer surface of the inner cylinder 31, and is connected to an inner surface of the outer cylinder 32. Note that the connecting portion 33 may be multiple rod-like members. In addition, the connecting portion 33 may be formed in an annular plate shape continuous in the circumferential direction.

The rotor 3 is fixed to the shaft 4, and the rotor 3 and the shaft 4 rotate simultaneously. As shown in FIG. 2 and other drawings, the rotor 3 is disposed on the radially outer side of the stator 1. That is, in the brushless motor A, the rotor 3 has the shaft 4 extending along the central axis and the magnet 34 having magnetic poles. Furthermore, the brushless motor A has the stator 1 that is located in the radial direction of the shaft 4, and holds each of the coils 13 of multiple phases so that the coil 13 faces the rotor 3.

The brushless motor A has the configuration described above. The brushless motor A is a six-pole nine-slot brushless DC motor including a six-pole magnet 34 and a nine-slot stator 1. Note that the number of poles and number of slots are not limited to those described above, and may be any number of poles and number of slots forming a brushless DC motor that can be driven.

By energizing the U-phase coil 13u, the V-phase coil 13v, and the W-phase coil 13w of the brushless motor A in a predetermined order in a predetermined direction, a magnetic field is generated in each coil 13. The magnetic field generated in each coil 13u, 13v, 13w varies depending on whether electricity is supplied thereto, and the direction in which the electricity is supplied. The magnetic field generated in each coil 13u, 13v, 13w and the magnetic field of the magnet 34 attract and repel each other, thereby generating a circumferential force in the rotor 3. This causes the rotor 3 and the shaft 4 to rotate relative to the casing 2 and the stator 1.

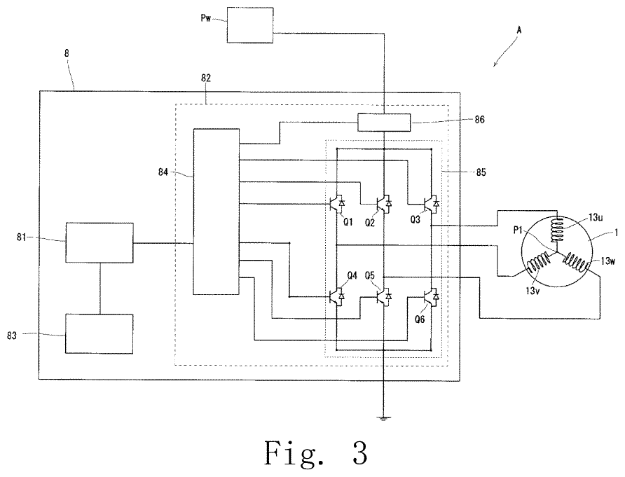

The brushless motor A is provided with a motor controller for rotating the rotor 3. Hereinafter, the motor controller will be described with reference to the drawings. FIG. 3 is a block diagram showing an electrically connected state of the brushless motor. As shown in FIG. 3, the brushless motor A is a Y connection in which the U-phase coil 13u, the V-phase coil 13v, and the W-phase coil 13w are connected at a neutral point P1. Note that while the example embodiment adopts a Y connection, a delta connection may be used instead.

The brushless motor A includes a motor controller 8 that supplies a current supplied from a power source Pw to the U-phase coil 13u, the V-phase coil 13v, and the W-phase coil 13w. The motor controller 8 includes an energization pattern determination portion 81, a current supply portion 82, and a timer 83. That is, the motor controller 8 controls rotation of the brushless motor A provided with the rotor 3 including the magnet 34 having magnetic poles and the stator 1 including the coils 13u, 13v and 13w of multiple phases.

The energization pattern determination portion 81 determines an energization pattern including information on which of the U-phase coil 13u, V-phase coil 13v, and W-phase coil 13w to supply a current, and the direction in which to supply the current. That is, the energization pattern determination portion 81 determines an energization pattern that specifies the coil to be energized from among the coils 13u, 13v, and 13w of multiple phases. The energization pattern is determined in advance, as will be described later. That is, the energization pattern determination portion 81 determines an energization pattern from among the predetermined energization patterns, and transmits the energization pattern to a controller 84 to be described later as energization pattern information. Details of the energization pattern will be described later.

The current supply portion 82 supplies a current to each of the coils 13u, 13v and 13w. The current supply portion 82 includes the controller 84, a switching circuit 85, and a current controller 86.

The switching circuit 85 is a circuit that allows a current to flow to the U-phase coil 13u, the V-phase coil 13v, and the W-phase coil 13w in a predetermined direction. The switching circuit 85 is a so-called inverter circuit including six switching elements Q1 to Q6. Note that in the following description, the switching elements Q1 to Q6 may be referred to as first to sixth switching elements Q1 to Q6. The switching elements Q1 to Q6 are elements that are turned ON or OFF based on a signal from the controller 84. While the example embodiment adopts a bipolar transistor, the disclosure is not limited to this, and an element such as an FET, a MOSFET, an IGBT, or the like that performs the same operation may be used.

As shown in FIG. 3, the emitter of the first switching element Q1 and the collector of the fourth switching element Q4 are connected. That is, the first switching element Q1 and the fourth switching element Q4 are connected in series. Similarly, the emitter of the second switching element Q2 is connected to the collector of the fifth switching element Q5, and the emitter of the third switching element Q3 is connected to the collector of the sixth switching element Q6. The collectors of the first switching element Q1, the second switching element Q2, and the third switching element Q3 are connected to each other, and are connected to the current controller 86. Further, the emitters of the fourth switching element Q4, the fifth switching element Q5, and the sixth switching element Q6 are connected to each other, and are grounded.

Then, the side opposite to the neutral point P1 of the V-phase coil 13v is connected to a connection line connecting the first switching element Q1 and the fourth switching element Q4. The side opposite to the neutral point P1 of the W-phase coil 13w is connected to a connection line connecting the second switching element Q2 and the fifth switching element Q5. Then, the side opposite to the neutral point P1 of the U-phase coil 13u is connected to a connection line connecting the third switching element Q3 and the sixth switching element Q6.

The controller 84 transmits an operation signal to the base terminal of each of the first to sixth switching elements Q1 to Q6. The switching elements Q1 to Q6 are OFF, that is, do not receive a current, when the base terminal thereof does not receive the operation signal from the controller 84 (when input signal is L). In addition, the switching elements Q1 to Q6 are ON, that is, receive a current, when they receive an operation signal from the controller 84 (when input signal is H).

The controller 84 determines ON or OFF of the switching elements Q1 to Q6 based on the energization pattern information sent from the energization pattern determination portion 81, and transmits an operation signal to the switching element to be turned ON. The controller 84 also controls the current controller 86. That is, the current supply portion 82 supplies a current to the coils 13u, 13v, and 13w based on the energization pattern.

The power source Pw converts alternating current into direct current and supplies it to the brushless motor A. The power source Pw includes a rectifier circuit and a smoothing circuit, which are not shown. The rectifier circuit converts alternating current into direct current using a diode bridge, for example. The smoothing circuit is a circuit that smooths fluctuations (pulsations) of a current using a resistor, a capacitor, and a coil, for example. Known circuits are used as the rectifier circuit and the smoothing circuit, and detailed descriptions thereof are omitted. The power source Pw is not limited to one that converts alternating current into direct current. The power source Pw may be a power source that supplies direct current to the brushless motor A by applying the direct current with the voltage as it is, stepping down the voltage, or stepping up the voltage.

The current controller 86 controls the current value, the supply start timing, the current waveform, and the like of the current supplied to the switching circuit 85 from the power source Pw. The controller 84 controls the current controller 86. The switching circuit 85 and the current controller 86 are controlled by the controller 84, and are in synchronization with each other. Note that while the current controller 86 is described as a circuit independent of the controller 84 in the motor controller 8 of the example embodiment, the current controller 86 may be included in the controller 84. In this case, the current controller 86 may either be provided as a part of a circuit of the controller 84, or be provided as a program that operates in the controller 84.

The timer 83 is connected to the energization pattern determination portion 81. The timer 83 measures time, and passes time information to the energization pattern determination portion 81. The energization pattern determination portion 81 determines the energization pattern based on the time information from the timer 83.

In the brushless motor A, supply of a current to the coils 13u, 13v and 13w is controlled by the motor controller 8 of the configuration. In addition, the brushless motor A described in the example embodiment is a sensorless brushless motor from which a sensor for detecting the position of the rotor 3 is omitted. In the following description, when a current flows toward the neutral point P1 from the current supply portion 82 through the coils 13u, 13v, and 13w, the side of the coils 13u, 13v, and 13w facing the rotor 3 is assumed to be the N pole.

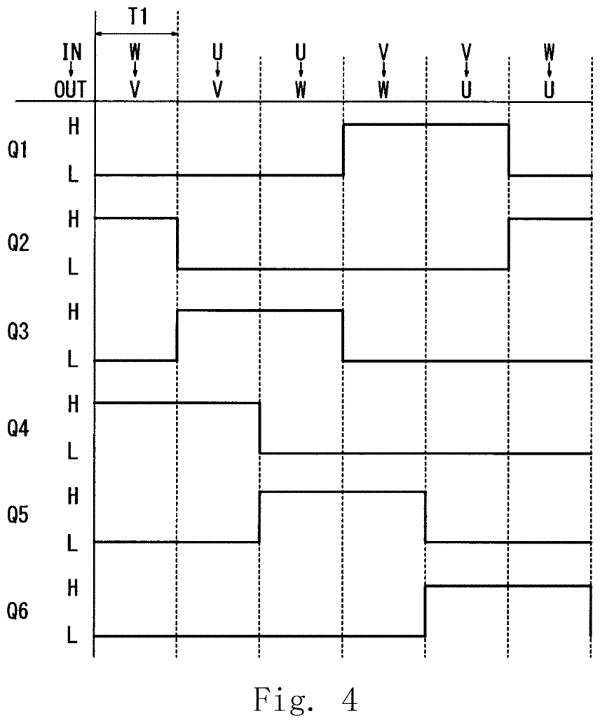

The energization pattern will be described with reference to the drawings. FIG. 4 is a diagram showing input signals and energization patterns of the switching circuit in a first operation mode. A first operation mode M1 is a mode that is executed when the rotor rotates at a constant rotation speed that is equal to or higher than a predetermined rotation speed (steady rotation). Further, in the timing chart shown in FIG. 4, the rotor 3 is rotated constantly, and this is the first operation mode. In FIG. 4, input signals to the first to sixth switching elements Q1 to Q6 are shown in this order from the top. That is, when the signal is at H, the switching element is ON.

By turning ON two switching elements other than the switching elements connected in series (Q1 and Q4, Q2 and Q5, Q3 and Q6) in the switching circuit 85, a current can be supplied to two coils from among the U-phase coil 13u, the V-phase coil 13v, and the W-phase coil 13w. For example, when the third switching element Q3 and the fourth switching element Q4 are turned ON, the current from the current controller 86 flows to the U-phase coil 13u, and to the V-phase coil 13v through the neutral point P1.

The energization pattern determined by the energization pattern determination portion 81 specifies a coil (IN coil) into which the current flows, and a coil (OUT coil) into which the current flowing through the IN coil flows via the neutral point P1. When a current flows into the U-phase coil 13u and then flows into the V-phase coil 13v, the U-phase coil 13u is the IN coil and the V-phase coil 13v is the OUT coil. The energization pattern in this case is a U-V pattern. In the case of the brushless motor A including the coils 13u, 13v, and 13w of three phases, there are six patterns which are a W-V pattern, the U-V pattern, a U-W pattern, a V-W pattern, a V-U pattern, and a W-U pattern. Note that in the brushless motor A, the energization pattern is switched in the above-mentioned order, and a current corresponding to the energization pattern is supplied to the coils 13u, 13v and 13w. This causes the rotor 3 to rotate in the counterclockwise (CCW direction).

In the timing chart shown in FIG. 4, the horizontal axis represents time. A period when an energization pattern is selected, in other words, a time between determination of a certain energization pattern and determination of the next energization pattern, is defined as an energization period. Then, the current supply portion 82 supplies a current to the coil 13 specified by the energization pattern in the energization period. The controller 84 continuously transmits a drive signal to a switching element during the energization period. That is, the switching element turned ON by the determination of the certain energization pattern maintains the ON state during the energization period. Note that the energization period of the first operation mode M1 shown in FIG. 4 is referred to as an energization period T1.

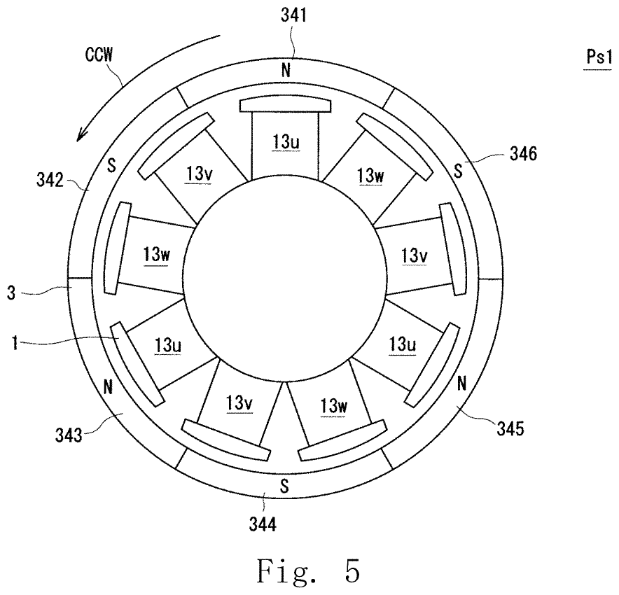

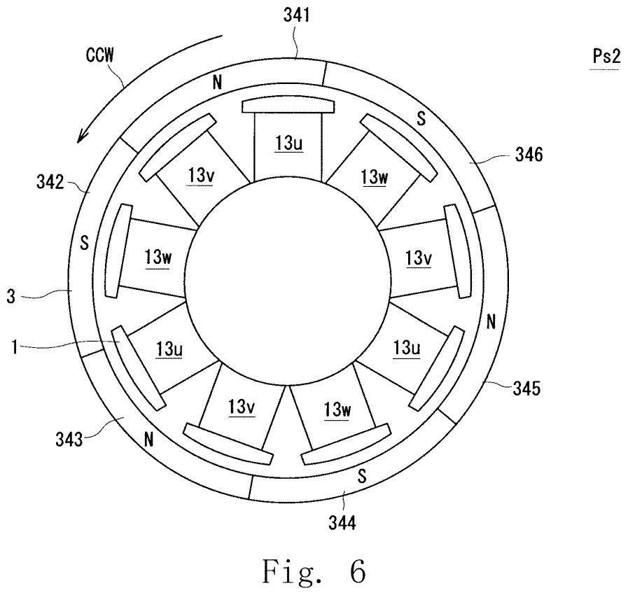

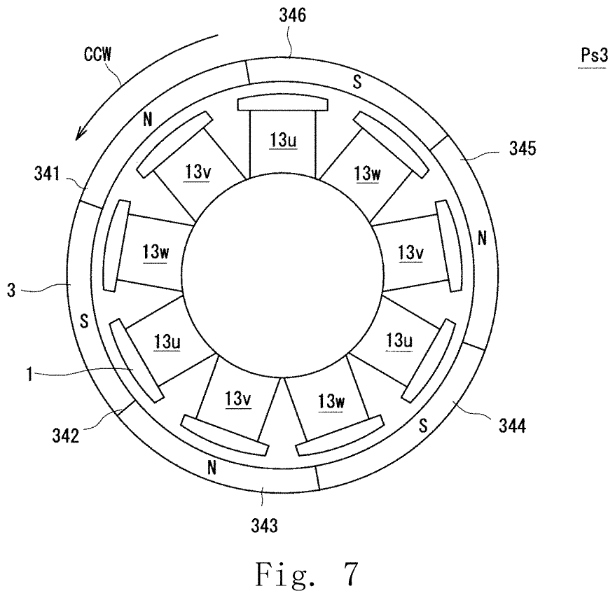

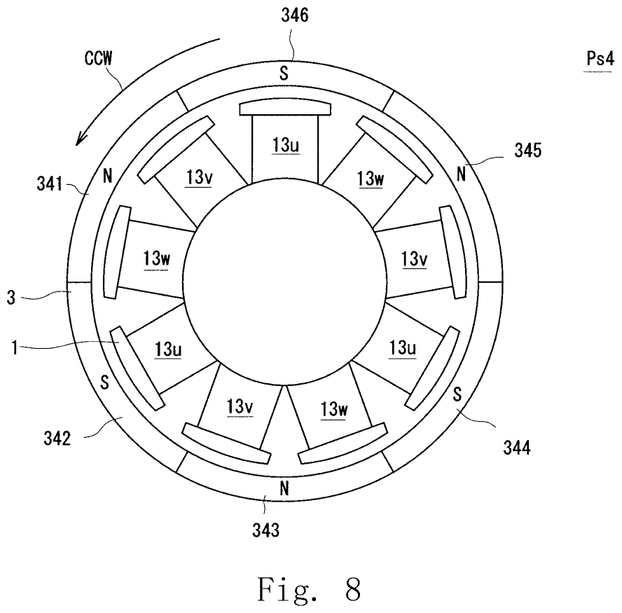

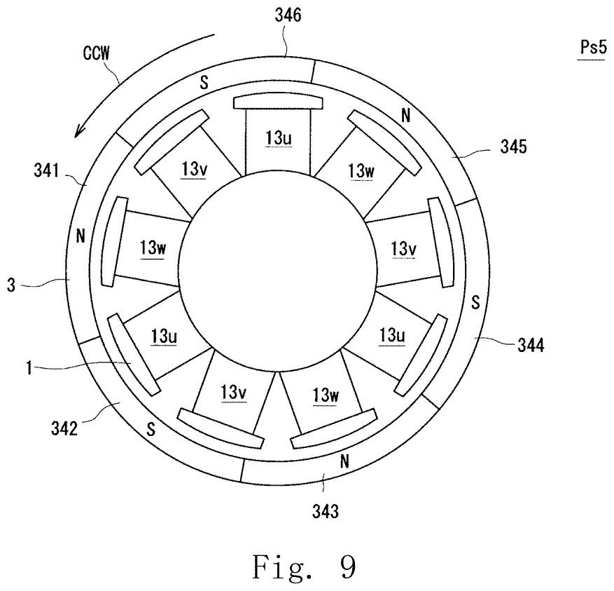

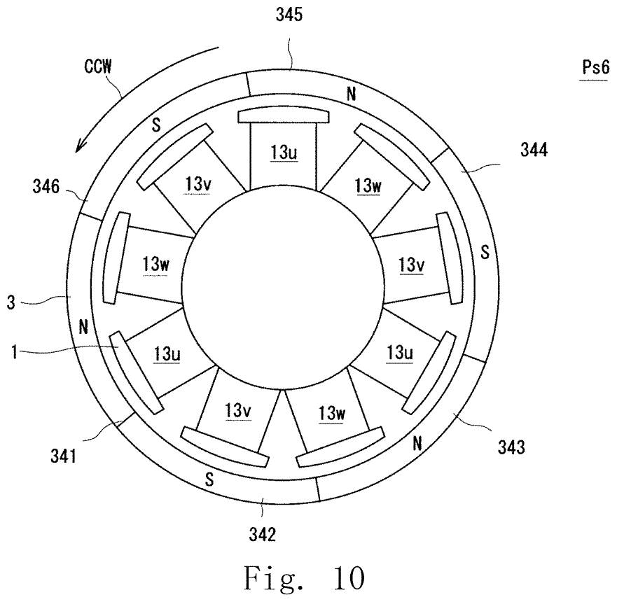

FIG. 5 is a diagram showing the brushless motor stopped in a first stop position. FIG. 6 is a diagram showing the brushless motor stopped in a second stop position. FIG. 7 is a diagram showing the brushless motor stopped in a third stop position. FIG. 8 is a diagram showing the brushless motor stopped in a fourth stop position. FIG. 9 is a diagram showing the brushless motor stopped in a fifth stop position. FIG. 10 is a diagram showing the brushless motor stopped in a sixth stop position.

While FIGS. 5 to 10 show the positional relationship between the coils 13u, 13v and 13w of the stator 1 and the magnet 34, the actual configuration includes the rotor 3, the shaft 4, and other parts. Further, the magnets 34 are distinguished as first to sixth magnets 341 to 346. In FIG. 5, the magnet located on the upper side is the first magnet 341, and the second to sixth magnets 342 to 346 are sequentially arranged in the counterclockwise direction. Furthermore, in FIGS. 5 to 10, magnetic poles (N pole or S pole) are shown on the first to sixth magnets 341 to 346 for better understanding.

The teeth 112 of the stator 1 of the brushless motor A are formed of a magnetic material such as a magnetic steel plate. When no current is supplied to the coils 13u, 13v and 13w, no magnetic flux is generated. Accordingly, in the brushless motor A, when the current supply is stopped, the teeth 112 and the magnet 34 attract each other by magnetic force regardless of the phase of the coil wound around the teeth 112. Then, when the rotation of the rotor 3 due to inertial force ends, the teeth 112 attract the magnet 34, and the attraction of the magnet 34 to the teeth 112 stops the rotor 3. The stop of the rotor 3 after stopping the supply of power is regarded as a natural stop, and the stop position is regarded as a natural stop position.

As shown in FIGS. 5 to 10, in the brushless motor A, multiple natural stop positions exist depending on the positions of the magnet 34 and the coils 13u, 13v, and 13w attached to the teeth 112. The natural stop positions of the rotor 3 shown in FIGS. 5 to 10 are natural stop positions of the six-pole nine-slot brushless motor A. The stop position of the rotor 3 changes with the number of poles and number of slots. Note that the stop positions in FIGS. 5 to 10 are referred to as first to sixth positions Ps1 to Ps6.

For example, the W-V pattern is determined as the energization pattern in the first position Ps1. As a result, the W-phase coils 13w are excited to the N pole and the V-phase coils 13v are excited to the S pole. The first magnet 341, the third magnet 343, and the fifth magnet 345 are attracted to the V-phase coils 13v excited to the S pole. In addition, the second magnet 342, the fourth magnet 344 and the sixth magnet 346 are attracted to the W-phase coils 13w excited to the N pole. This moves the rotor 3 in the counterclockwise direction (CCW direction). The rotor 3 moves to the second position Ps2 shown in FIG. 6.

When the rotor 3 is in the second position Ps2, the energization pattern is set to the U-V pattern. As a result, the U-phase coils 13u are excited to the N pole and the V-phase coils 13v are excited to the S pole. The second magnet 342, the fourth magnet 344, and the sixth magnet 346 are attracted to the U-phase coils 13u excited to the N pole. In addition, the first magnet 341, the third magnet 343, and the fifth magnet 345 are attracted to the V-phase coils 13v excited to the S pole. This moves the rotor 3 in the counterclockwise direction (CCW direction). The rotor 3 moves to the third position Ps3 shown in FIG. 7.

Thereafter, energization by the U-W pattern moves the rotor 3 to the fourth position Ps4 shown in FIG. 8, and energization by the V-W pattern moves the rotor 3 to the fifth position Ps5 shown in FIG. 9. Then, energization by the V-U pattern moves the rotor 3 to a sixth position Ps6 shown in FIG. 10. Then, energization by the W-U pattern while the rotor 3 is in the sixth position Ps6 causes the rotor 3 to rotate by 120 degrees from the first position Ps1 shown in FIG. 5.

In the brushless motor A, the rotor 3 is rotated by switching the energization pattern and supplying a current to the coils 13u, 13v, and 13w. The rotation speed of the rotor 3 can be changed by changing the energization period T1. For example, by shortening the energization period T1, the time before reaching the next position is shortened, that is, the rotation speed increases. Further, in the brushless motor A, the torque (force) acting on the rotor 3 changes with the supplied current.

As shown in FIGS. 1 and 2, in the brushless motor A, the coils 13u, 13v, and 13w are wound around the teeth 112 of the stator core 11 of the magnetic steel plate. Supply of current to the coils 13u, 13v, and 13w causes the rotor 3 to rotate. At this time, the coils 13u, 13v, and 13w are heated by Joule heat, and the stator core 11 is also heated by induction heating of the coils 13u, 13v, and 13w. In the brushless motor A, the magnetic characteristics of the magnet 34 may change due to a temperature rise, and the rotation characteristics may be degraded. Further, in the brushless motor A, there are cases where electronic components that are easily broken or damaged due to heating of the controller 84, the switching circuit 85, or the like are arranged around these components.

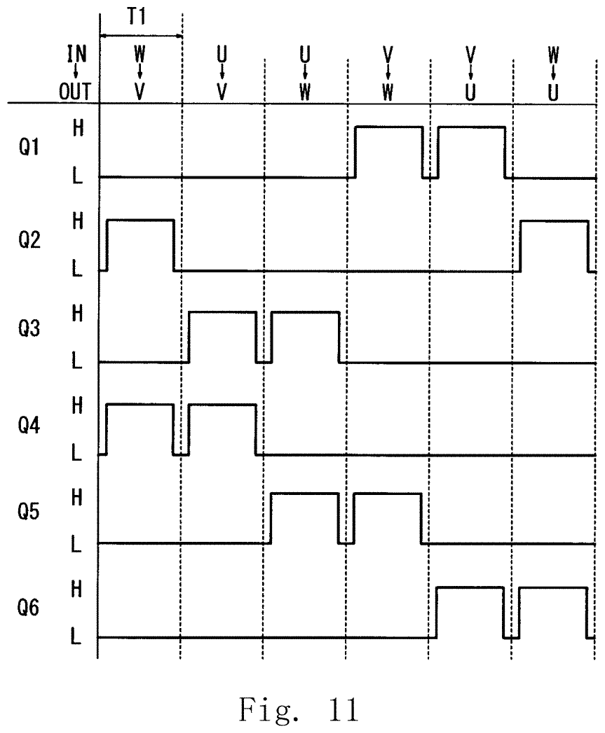

Against this background, the controller 84 of the motor controller 8 includes a second operation mode M2 for reducing the effective value of current as compared to the first operation mode M1. FIG. 11 is a diagram showing input signals and energization patterns of the switching circuit in a second operation mode. FIG. is an enlarged view of an energization period of in second operation mode shown in FIG. 11.

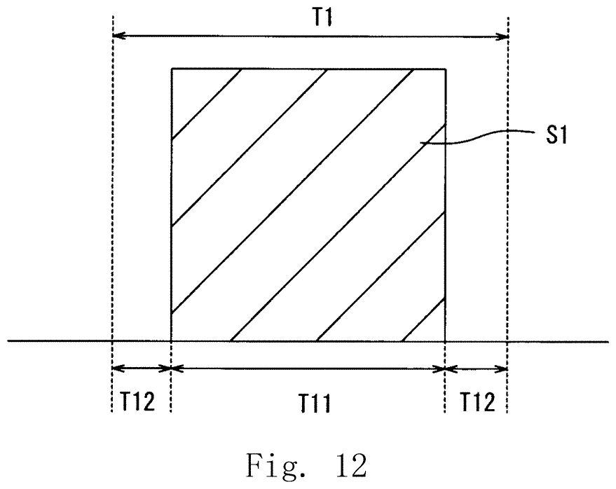

As shown in FIGS. 11 and 12, in the second operation mode M2, a supply period T11 and a stop period T12 are provided in the energization period T1. In the supply period T11, the switching elements Q1 to Q6 are turned ON to supply current to the coils 13u, 13v, and 13w. In the stop period T12, the switching elements Q1 to Q6 are turned OFF to stop the supply of current to the coils 13u, 13v, and 13w. In other words, the energization period T1 of the first operation mode M1 is only the supply period T11. That is, the current supply portion 82 includes the first operation mode M1 in which the energization period T1 is only the supply period T11 for supplying current, and the second operation mode M2 in which the energization period T1 includes the supply period T11 and the stop period T12 for stopping the current supply.

Thus, in the second operation mode M2, the energization period T1 includes the supply period T11 for supplying current and the stop period T12 for stopping the supply. As described above, by controlling the current supplied by the current supply portion 82, it is possible to lower the effective value of current supplied to the coils 13u, 13v, and 13w in the energization period T1. This suppresses Joule heat and induction heat generation.

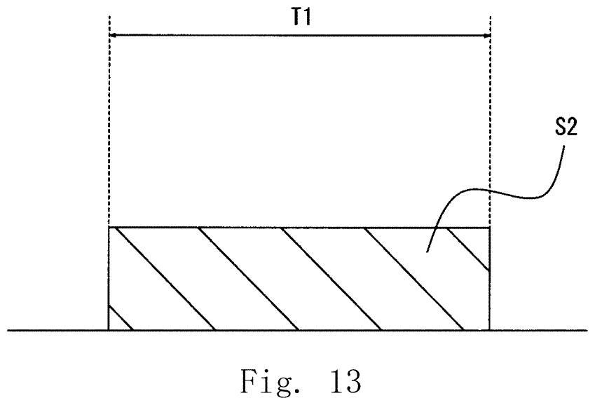

The supply period T11 and the stop period T12 will be described in detail. FIG. 13 is a diagram showing the minimum value of the sum total of the currents that rotate the rotor in a single energization period. In the brushless motor A, the torque acting on the rotor 3 is determined by the current supplied to the coils 13u, 13v, and 13w. In order for the rotor 3 to rotate, a torque larger than the cogging torque needs to act on the rotor 3. Further, in order for the rotor 3 to continue rotating, it is necessary to supply, to the coils 13u, 13v, and 13w, energy of an equal or larger amount of work necessary for the rotor 3 to continue rotating. Then, assuming that the voltages applied to the coils 13u, 13v, and 13w are constant, the sum total of the currents supplied to the coils 13u, 13v, and 13w in the energization period is the amount of work of the rotor 3. As shown in FIG. 13, the minimum value of the sum total of the currents that rotate of the rotor 3 is S2.

As shown in FIG. 12, the sum total of the currents supplied during the energization period T1 in the second operation mode M2 is S1. At this time, the sum total S1 of the currents in the energization period T1 in the second operation mode M2 is larger than the minimum value S2 of the sum total of the currents necessary for the rotation of the rotor 3. That is, the ratio of the supply period T11 to the energization period T1 in the second operation mode M2 is such that the sum total S1 of the currents supplied in the energization period T1 is larger than the minimum value S2 of the sum total of the currents that rotate the rotor 3.

As described above, since the sum total S1 of the currents and the minimum value S2 of the sum total of the currents hold, the rotation of the rotor 3 is continued even if the stop period T12 is provided in the energization period T1.

Furthermore, when the stop period T12 is provided in the second operation mode M2, in the stop period T12, no current is supplied to the coils 13u, 13v, and 13w, and therefore no torque acts on the rotor 3. Hence, by providing the supply period T11 and the stop period T12 in the energization period T1, the torque acting on the rotor 3 fluctuates in the energization period T1. When the stop period T12 is short, the rotor 3 is rotated by the inertial force of the rotor 3 and equipment attached to the rotor 3. Accordingly, the change in the rotation speed of the rotor 3 is small even if no torque is applied. On the other hand, when the stop period T12 becomes long, the time in which the torque is not acting becomes long, and the change in the rotation speed of the rotor 3 increases. Such a change in rotation speed causes vibration of the brushless motor A. For this reason, it is preferable that the stop period T12 be short.

For example, assuming that the ratio of the supply period T11 to the energization period T1 is a, the ratio a that can reduce the change in rotation speed while suppressing the effective value of current can be ¾ or more.

As described above, the current supply portion 82 includes the second operation mode M2 provided with the stop period T12 in which no current is supplied to the coils 13u, 13v, and 13w. By providing the second operation mode M2, the current to the coils 13u, 13v and 13w is stopped while the inertial force of the rotor 3 and equipment attached to the rotor 3 acts. Hence, the effective value of current can be reduced while suppressing fluctuation in the rotational accuracy (e.g., rotation speed) of the rotor 3. That is, it is possible to suppress power consumption and suppress temperature rise of the brushless motor A, while suppressing fluctuation of the rotational accuracy (e.g., rotation speed) of the rotor 3.

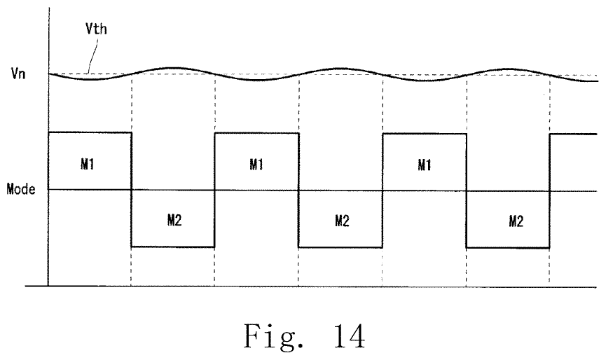

Another example of the brushless motor of the present disclosure will be described with reference to the drawings. FIG. 14 is a timing chart showing an operation of the brushless motor of the present disclosure. The configurations of a brushless motor A and a motor controller 8 in this example embodiment are the same as those of the first example embodiment. Hence, the description of the detailed configuration is omitted. Further, the configurations of the brushless motor A and the controller 8 are similar to those of the first example embodiment. In FIG. 14, the upper part shows the change over time of a voltage Vn applied from the power source Pw to the current supply portion 82. The lower part shows the operation mode of the current supply portion 82.

As described above, the current supply portion 82 of the motor controller 8 of the present disclosure has the first operation mode M1 and the second operation mode M2. The effective value of current can be reduced by supplying current to the coils 13u, 13v, and 13w in the second operation mode M2.

As shown in FIG. 3, in the brushless motor A, alternating current is converted into direct current by the power source Pw. While the power source Pw is provided with a smoothing circuit, the voltage Vn applied to the current supply portion 82 fluctuates within a constant width. Hence, the current supplied to the coils 13u, 13v, and 13w from the current supply portion 82 also fluctuates within a constant width. Accordingly, the current supply portion 82 operates in the second operation mode M2 to reduce the effective value of the current supplied to the coils 13u, 13v, and 13w from the current supply portion 82, when the applied voltage Vn is equal to or higher than a predetermined value. That is, the current supply portion 82 operates in the first operation mode M1 when the externally supplied voltage Vn is smaller than a predetermined voltage Vth, and switches to the second operation mode M2 when the externally supplied voltage Vn is equal to or higher than the predetermined voltage Vth.

That is, as shown in FIG. 14, when the applied voltage Vn is smaller than the threshold value Vth, the controller 84 controls the current supply portion 82 in the first operation mode M1. Further, when the applied voltage Vn is equal to or higher than the threshold value Vth, the controller 84 controls the current supply portion 82 in the second operation mode M2. By driving the current supply portion 82 in this manner, it is possible to suppress an increase in the effective value of the current supplied to the coils 13u, 13v, and 13w due to the ripple of the applied voltage Vn. As a result, power consumption can be suppressed, and temperature rise of the brushless motor A due to Joule heat of the coils 13u, 13v, and 13w and induction heating of the stator core 11 can be suppressed.

In FIG. 14, the first operation mode M1 and the second operation mode M2 are switched according to the magnitude of the applied voltage Vn and the threshold value Vth. However, in practice, the magnitude of the applied voltage Vn and the threshold value Vth may change in the middle of the energization period T1. In that case, the operation in the current operation mode may be continued until the end of the current energization period T1, and the operation mode may be switched when the energization period T1 is switched.

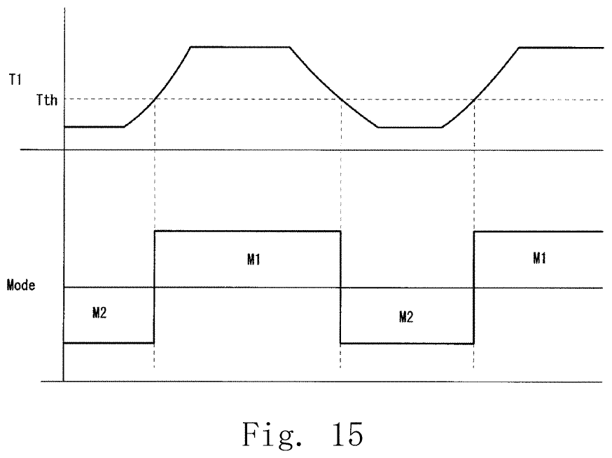

Another example of the brushless motor of the disclosure will be described with reference to the drawings. FIG. 15 is a timing chart showing an operation of the brushless motor of the present disclosure. The configurations of a brushless motor A and a motor controller 8 in this example embodiment are the same as those of the first example embodiment. Hence, the description of the detailed configuration is omitted. In FIG. 15, the upper part shows the change over time of the energization period T1. The lower part shows the operation mode of the current supply portion 82.

As described above, it is possible to change the rotation speed of the rotor 3 by changing the energization period T1. In the brushless motor A, when the energization period T1 is short, the rotation speed of the rotor 3 is higher than when the energization period T1 is long.

For example, when the rotation speed of the rotor 3 is high, the inertial force of the rotor 3 and equipment attached to the rotor 3 is larger than that when the rotation speed is low. That is, when the rotation speed of the rotor 3 is high, even if the torque acting on the rotor 3 is stopped, the rotation speed of the rotor 3 does not easily decrease. On the other hand, when the rotation speed is low, if the torque acting on the rotor 3 is stopped, the rotation speed of the rotor 3 decreases easily.

For this reason, the controller 84 retains an energization period when the rotation speed of the rotor 3 is a predetermined rotational speed as a threshold Tth. Then, when the length of the energization period T1 is equal to or less than the threshold Tth, that is, when the rotation speed of the rotor 3 is equal to or higher than a predetermined speed, the controller 84 controls the current supply portion 82 in the second operation mode M2. Further, when the length of the energization period T1 is longer than the threshold Tth, that is, when the rotation speed of the rotor 3 is lower than a predetermined speed, the controller 84 controls the current supply portion 82 in the first operation mode M1. That is, the current supply portion 82 operates in the first operation mode M1 when the length of the energization period T1 is longer than the predetermined length Tth. The current supply portion 82 operates in the second operation mode M2 when the length of the energization period T1 is equal to or less than the predetermined length Tth.

That is, the current supply portion 82 switches between the first operation mode M1 and the second operation mode M2 by comparing the length of the energization period T1 and the length of the threshold Tth. In other words, when the rotation speed of the rotor 3 is high and rotation is easily maintained by the inertial force, the current supply portion 82 operates in the second operation mode M2 in which the effective value of current can be reduced. Further, when the rotation speed of the rotor 3 is low and rotation is difficult to maintain by the inertial force, the current supply portion 82 operates in the first operation mode M1. As described above, the current supply portion 82 operates by switching between the first operation mode M1 and the second operation mode M2, thereby reducing the effective value of current while suppressing fluctuation in the rotational accuracy (e.g., rotation speed) of the rotor 3. That is, it is possible to suppress power consumption and suppress temperature rise of the brushless motor A, while suppressing fluctuation in the rotational accuracy (e.g., rotation speed) of the rotor 3.

While the brushless motor A described above is a so-called sensorless type that does not have a sensor for detecting the position of the rotor 3, the disclosure is not limited to this. For example, a detector such as a rotor position detection sensor including a Hall element or the like, or a detection circuit that detects the position of the rotor based on induced electromotive force may be provided. In the case of such a configuration, the energization period T1 is determined based on the information on the position of the rotor 3 acquired by the detector. Even in such a case, similarly, the current supply portion 82 may include the first operation mode M1 and the second operation mode M2.

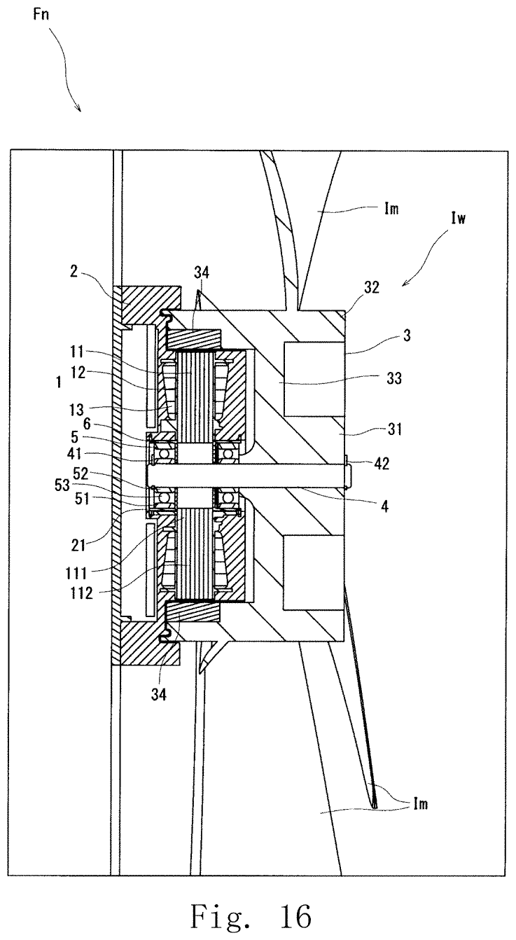

A fan as an example of a device using a brushless motor of the present disclosure will be described with reference to the drawings. FIG. 16 is an enlarged cross-sectional view of an essential part of an example of a fan of the present disclosure. FIG. 16 shows an enlarged cross-sectional view of a portion to which a brushless motor A is attached.

A fan Fn includes the brushless motor A. A rotor 3 fixed to a shaft 4 is formed of the same member as an impeller Iw. That is, the fan Fn includes the brushless motor A and the impeller Iw attached to the shaft 4 and rotating with the shaft 4. The fan Fn includes an impeller Im provided on the outer periphery of an outer cylinder 32 of the rotor 3. The impellers Im are arranged at equal intervals in the circumferential direction around the shaft 4. The impeller Im generates an axial air flow as the rotor 3 rotates. Note that the impeller Iw may be configured as a separate member from the rotor 3. At this time, the impeller Iw includes a cup member joined to the rotor 3, and the impeller Im is provided on the outer periphery of the cup member.

The fan Fn may be provided, for example, in a device such as a hair dryer that a user holds during use. By using the brushless motor A of the present disclosure for the fan Fn, it is possible to suppress power consumption while suppressing fluctuation in the rotational accuracy (e.g., rotation speed) of the rotor of the fan Fn.

While the example embodiments of the present disclosure have been described above, the example embodiments can be modified in various ways within the scope of the present disclosure.

The present disclosure can be used as a motor for driving a fan provided in a hair dryer or the like.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-10. (canceled)

11: A motor controller that controls rotation of a brushless motor including a rotor that includes a magnet having magnetic poles, and a stator that includes coils of a plurality of phases, the motor controller comprising:
an energization pattern determiner that determines an energization pattern that specifies a coil to be energized from the coils of a plurality of phases; and
a current supply that, assuming that an energization period is a time from determination of the energization pattern to determination of a next energization pattern, supplies a current to a coil specified by the energization pattern in the energization period; wherein
the current supply includes:
a first operation mode in which the energization period is only a supply period that supplies current; and
a second operation mode in which the energization period includes the supply period and a stop period that stops current supply.

12: The motor controller according to claim 11, wherein a ratio of the supply period to the energization period in the second operation mode is such that a sum total of currents supplied in the energization period is larger than a minimum value of a sum total of currents that rotate the rotor.

13: The motor controller according to claim 11, wherein the current supply operates in the first operation mode when a length of the energization period is longer than a predetermined length, and is switched to operation in the second operation mode when the length of the energization period is equal to or shorter than the predetermined length.

14: The motor controller according to claim 11, wherein the current supply operates in the first operation mode when an externally supplied voltage is lower than a predetermined voltage, and is switched to operation in the second operation mode when the externally supplied voltage is equal to or higher than the predetermined voltage.

15: A brushless motor comprising:
a rotor including a shaft extending along a central axis and a magnet including magnetic poles;
a stator located in the radial direction of the shaft, and holding each of coils of a plurality of phases to face the rotor; and
the motor controller according to claim 11.

16: A fan comprising:
the brushless motor according to claim 15; and
an impeller attached to the shaft and rotatable with the shaft.

17: A motor control method that controls rotation of a brushless motor including a rotor that includes a magnet including magnetic poles, and a stator that includes coils of a plurality of phases, the motor control method comprising the steps of:
determining an energization pattern that specifies a coil to be energized from the coils of a plurality of phases;
assuming that an energization period is a time from determination of the energization pattern to determination of a next energization pattern, supplying a current to a coil specified by the energization pattern; and
supplying the current to the coil by executing a plurality of operation modes including:
a first operation mode in which the energization period includes only a supply period that specifies a current, and
a second operation mode in which the energization period includes the supply period and a stop period that stops current supply.

18: The motor control method according to claim 17, wherein a ratio of the supply period to the energization period in the second operation mode is such that a sum total of currents supplied in the energization period is larger than a minimum value of a sum total of currents that rotate the rotor.

19: The motor control method according to claim 17, wherein operation in the first operation mode is performed when a length of the energization period is longer than a predetermined length, and the operation is switched to the second operation mode when the length of the energization period is equal to or shorter than the predetermined length.

20: The motor control method according to claim 17, wherein operation in the first operation mode is performed when an externally supplied voltage is lower than a predetermined voltage, and the operation is switched to the second operation mode when the externally supplied voltage is equal to or higher than the predetermined voltage.
